(19) United States
(12) Patent Application Publication
(10) Pub. No.: US 2022/0084035 A1
(43) Pub. Date: Mar. 17, 2022

(54) SYSTEM AND METHOD FOR FACILITATING DIRECT TRADING OF ELECTRONIC TRANSACTIONS

(71) Applicant: Mira Fintech, Inc., The Colony, TX (US)

(72) Inventors: Benayhou BALTSAN, The Colony, TX (US); Yosi MORIK, Chicago, IL (US); Lawrence Ira SCHULMAN, Chicago, IL (US); Tamir EDEN, Ra'anana (IL)

(73) Assignee: Mira Fintech, Inc., The Colony, TX (US)

(21) Appl. No.: 17/472,135

(22) Filed: Sep. 10, 2021

Related U.S. Application Data
(60) Provisional application No. 63/077,039, filed on Sep. 11, 2020.

(51) Int. Cl. G06Q 20/40; G06Q 40/04; G06Q 40/02; G06Q 20/38

(52) U.S. Cl. CPC G06Q 20/4016; G06Q 20/389; G06Q 40/025; G06Q 40/04

(57) ABSTRACT

A method and system for facilitating direct trading of electronic transactions are provided. The method includes receiving a request to approve an electronic transaction; determining if the received electronic transaction is approved based in part on a risk score set for the received electronic transactions; tranching the received electronic transaction in a transferable tranche, wherein the transferable tranche includes a plurality of plurality of approved electronic transactions issued by at least two different users; and providing the transferable tranche to a trading platform to perform at least one action on each of the approved electronic transactions.

### CROSS-REFERENCE TO RELATED APPLICATIONS

This application claims the benefit of U.S. Provisional Application No. 63/077,039 filed on Sep. 11, 2020, the contents of which are hereby incorporated by reference.

### TECHNICAL FIELD

The disclosure generally relates to electronic transactions processing systems for facilitating direct trading of electronic transactions.

### BACKGROUND

The electronic monetary transactions market is currently filled with many types of means for payments, such as credit cards, debit cards, stored value cards, loans, and the like, all of which may be offered by different issue vendors and providers. Such cards may be physical or virtual (e.g., embedded in a smartphone).

In any such transaction, there is a financial institution that either issues the credit card, and thereby provides the credit or loan. A standard credit card transaction includes paying at a merchant (where the card may be present or not), authorizing the transaction, and sending an authorization to the merchant. The payment is made by the financial institution (creditor) to the merchant and later collected from a user (debtor). The authorization is based on the available credit of the debtor and possibly additional fraud detection techniques. However, the authorization is not based on a current risk assessment of whether the debtor can repay. Typically, such a check is performed on the card that is issued to the debtor. However, financial situations may improve or worsen since the card was issued, thus the risk assessment of a debtor may not be current. Currently, there is no method for determining the risk per transaction request by a debtor.

The current credit model is monopoly based which engenders many disadvantages. One disadvantage of monopoly based credit models is the high costs passed to both merchants and borrowers. For merchants, the creditors charge a certain percentage (commission) of each transaction, and for the debtors, interest is charged on the total unpaid balance. With respect to the merchants, the high commission is justified, in part, on the costs of fraudulent transactions or unpaid transactions. Further, current solutions cause financial damages to merchants as some merchants may be required to reimburse the creditors for fraudulent transactions, or the merchant may have their legitimate transaction denied by the creditors.

Any attempt to determine the risk per transaction using conventional solutions is infeasible as such solutions do not include processes for determining the risk per transaction, and their compute infrastructure cannot support such transactions. Further, any attempt to offer competing terms to the transactor is infeasible in the current systems due to the inability to have the transactors interact with multiple issuers simultaneously. The current credit model ends up charging transactors (borrowers) interest rates that are not commensurate with the true default risk because of the monopolistic practices in credit offers that exist.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for facilitating direct trading of electronic transactions. The method comprises receiving a request to approve an electronic transaction; determining if the received electronic transaction is approved based in part on a risk score set for the received electronic transactions; tranching the received electronic transaction in a transferable tranche, wherein the transferable tranche includes a plurality of plurality of approved electronic transactions issued by at least two different users; and providing the transferable tranche to a trading platform to perform at least one action on each of the approved electronic transactions.

Certain embodiments disclosed herein also include a non-transitory computer readable medium having stored thereon causing a processing circuitry to execute a process, the process comprising: receiving a request to approve an electronic transaction; determining if the received electronic transaction is approved based in part on a risk score set for the received electronic transactions; tranching the received electronic transaction in a transferable tranche, wherein the transferable tranche includes a plurality of plurality of approved electronic transactions issued by at least two different users; and providing the transferable tranche to a trading platform to perform at least one action on each of the approved electronic transactions.

Certain embodiments disclosed herein also include a system for facilitating direct trading of electronic transactions. The system comprises: a processing circuitry; and a memory, the memory containing instructions that, when executed by the processing circuitry, configure the system to: receive a request to approve an electronic transaction; determine if the received electronic transaction is approved based in part on a risk score set for the received electronic transactions; tranche the received electronic transaction in a transferable tranche, wherein the transferable tranche includes a plurality of plurality of approved electronic transactions issued by at least two different users; and provide the transferable tranche to a trading platform to perform at least one action on each of the approved electronic transactions.

According to certain disclosed embodiments, the received electronic transaction is a credit request transaction and wherein the transferable tranche is a credit tranche.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram depicting the various disclosed embodiments of the payment system.

FIG. 2 is a flow diagram illustrating the monetary transactions according to the disclosed embodiments.

FIG. 3 is a flowchart illustrating a method for a direct credit payment according to an embodiment.

FIG. 4 illustrates the generation of credit tranches according to an embodiment.

FIG. 5 is a block diagram of the payment system according to an embodiment.

FIG. 6 is a diagram illustrating the logical functions of the payment system according to an embodiment.

### DETAILED DESCRIPTION

The embodiments disclosed by the invention are only examples of the many possible advantageous uses and implementations of the innovative teachings presented herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include a direct payment system that provides a credit-based purchase without the need for traditional creditors, i.e., credit card issuer. The direct payment system, in an embodiment, includes: brokers between a merchant (vendor), a debtor, and a creditor while determining the risk per each transaction. The risk is as whether the transactions would be paid. As such, the disclosed payment system may be designed to increase the number of authorized transactions by reducing the rate of rejected legitimate transactions. As the disclosed payment system may reduce the risk for both creditors and vendors, the financing cost (commission) for transactions can be reduced.

The disclosed system and method provide several technical improvements over prior art solutions. For example, the disclosed payment system operates in real-time and reduces the processing time of transaction review and approval. The disclosed payment system reduces the cycle time for payment execution, improves the reliability of each component, secures the system from fraudulent use, and improves transparency. Further, the disclosed system significantly reduces the number of failures and errors compared to existing solutions.

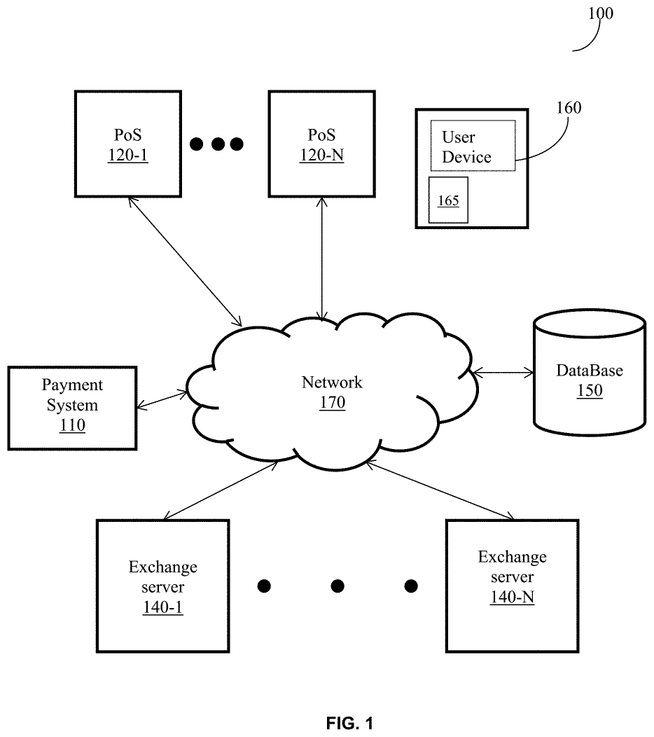

FIG. 1 is an example network diagram 100 depicting the various disclosed embodiments of the payment system. The network diagram 100 illustrates a payment system 110, one or more point of sale (PoS), 120-1 through 120-N (hereinafter, “PoS” 120 or “PoS” 120), one or more financial servers, 140-1-1 through 140-N (hereinafter “server” 140 or “servers” 140), and a database 150. Further, the various components shown in FIG. 1 are interconnected via a network 170.

The network 170 provides interconnectivity among the various components of the system. The network 170 may be, but is not limited to, a wireless, cellular, or wired network, a local area network (LAN), a wide area network (WAN), a metro area network (MAN), the Internet, the worldwide web (WWW), similar networks, and any combination thereof. The network may be a full-physical network, including exclusively physical hardware, a fully-virtual network, including only simulated or otherwise-virtualized components, or a hybrid physical-virtual network, including both physical and virtualized components. Further, the network 170 may be configured to encrypt data, both at rest and in motion, and to transmit encrypted, unencrypted, or partially-encrypted data.

The network 170 may be configured to connect to the various components of the network diagram 100 via wireless means such as, as examples and without limitation, Bluetooth™, long-term evolution (LTE), Wi-Fi, other, like, wireless means, and any combination thereof, via wired means such as, as examples and without limitation, Ethernet, universal serial bus (USB), other, like wired means, and any combination thereof. Further, the network 150 may be configured to connect with the various components shown in FIG. 1 via any combination of wired and wireless means.

A PoS 120 is a system for processing payments at merchant locations. The PoS 120 may include a dedicated terminal, an application installed on a smartphone or tablet computer, an e-commerce server, and the like. In an embodiment, the PoS 120 includes an agent installed therein and configured to interface with the payment system 110.

In an embodiment, a user (not shown) can make a purchase when the user is present at the retail location, or not. The purchase may be performed by an application or widget installed on a user device. Such an application or widget is configured to interact with the user device.

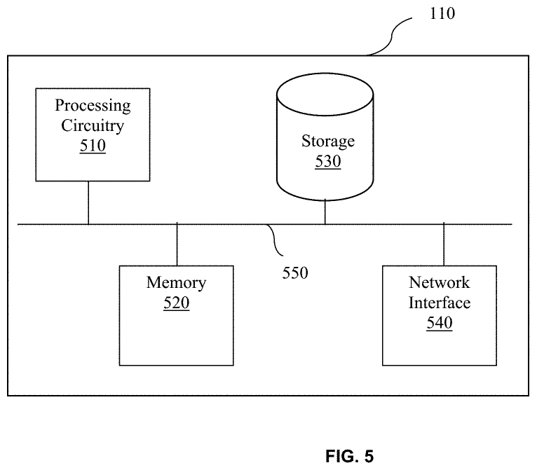

The payment system 110, depicted in detail with respect to FIG. 5, below, is a system configured to execute instructions, organize information, and otherwise process data. The payment system 110 may be configured to execute the methods described hereinbelow, other like methods, and any combination thereof. As described with respect to FIG. 5, below, the payment system 110 may include various processing, memory, networking, and other components allowing the payment system 110 to execute instructions and provide data processing. The payment system 110 may be implemented as physical hardware, as software virtualizing physical hardware, or as a combination of physical and virtualized components. The payment system 110 may be connected to the network 170 via those means described with respect to the network 170, above. Further, the payment system 110 may be deployed in a cloud computing platform, such as a public cloud, a private cloud, a hybrid cloud, or a combination thereof. In an embodiment, the payment system 110 can be realized using edge computing technologies. The various processes performed by the payment system 110 are described in greater detail hereinbelow.

According to the disclosed embodiments, the payment system 110 is configured to execute instructions for authorizing and financing transactions received from the PoS 120. The payment system 110 is configured to reduce the processing failure rate (i.e., rejecting legitimate transactions) compared to existing payment systems, thus, reducing risk and cost for users, vendors, and creditors.

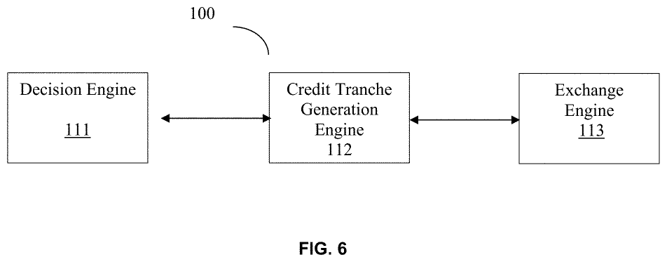

In an example embodiment, illustrated in FIG. 6, the payment system 110 includes a decision engine 111, a credit tranche generation engine 112, and an exchange engine 113. Each engine may be realized in hardware, software, firmware, or combination thereof. For example, each engine may be realized as a virtual machine (or other virtual entity) that may be hosted in different locations in a cloud platform, datacenter(s), and the like. In some configurations, the exchange engine may be included in a server 140. The elements discussed above can communicate using an application programming interface (API) with external systems and/or with other components of the system.

As will be discussed in detail below, the decision engine 111 is configured to decide if to allow or deny each payment transaction request received at a PoS 120. The credit tranche generation engine 112 is configured to aggregate allowed transactions and generate tranches respective thereof. Each tranche is associated with a determined risk and the total debt of the transactions in the tranche.

The exchange engine 113 is configured to broker the sale of the debt in tranches generated by the engine 112 to financial institutions. Financial institutions may bid on each credit tranche. A designated financial institution (a market maker) is obligated to bid continuously, and thus provide transparency to the ecosystem and be the buyer of last resort for the credit tranche. The exchange engine 113 continuously communicates the market bids to the engine 112 so that payment terms can be continuously adjusted to reflect the current market condition and presented to the user.

The servers 140 are systems of financial institutions, that may be configured to place a bid, receive currency, and wire currency. The servers 140 may include legacy systems, virtual servers, physical servers, and the like.

The database 150 is a data store configured to archive data permanently or semi-permanently. The database 150 may be configured to store information received from the servers 140 and the payment system 110. Further, the database 150 may be configured as a full-physical system, including exclusively physical components, as a virtualized system, including only virtualized components, or as a hybrid physical-virtual system. The database 150 may include, without limitation, local database hardware, cloud storage systems, remote storage servers, other, like, devices, and any combination thereof.

According to an embodiment, the database 150 may be configured to store or otherwise archive data relating to payment transaction requests (denied or allowed), information related to users, financial institutions, credit tranches, and the like.

In an embodiment, in order to pay for goods or services, a user is required to make the payment through a user device 160. The user device 160 includes an application, an agent, widget, or any piece of code (hereinafter “payment app” 165) that would allow to transact with the PoS 120. The payment app 165 also monitors the activity of a user of the user device 160. For example, the activity may include payment made by the user, places visited, purchasing patterns, interactions with other services/applications installed in the user device 160, and the like.

The user device 160 may include, but is not limited to, a smartphone, a personal computer, a tablet computer, a wearable device, a smart card, and the like. The payment app 165, and thus the user device 160, can transact with the PoS 120 using technologies such as, but not limited to, near field communication, QR codes, BLE signals, cellular signals, and the like.

It should be noted that one user device 160 is shown in FIG. 1 merely for ease of the descriptions, and in a particular configuration, the payment system 110 can interact with multiple user devices and process multiple different transactions in parallel.

The disclosed solution involves at least two different financial institutions. For example, a first institution transfers the payment to vendors and a second institution buys the debt from the first institution, which is also responsible for collecting payments from users and pay the debt through the tranche to the second institution. It should be appreciated that such a payment method would reduce the commissions' charge to the vendors as there is a risk determined for each transaction and tranche. The determined risks are computed according to the embodiments disclosed herein and would increase the likelihood of collecting money from debtors. Further, as the second institution is selected through a bidding process, the institution offering the optimal terms (e.g., interest rate and payment term) would be selected. This could reflect additional savings offered to debtors and vendors. It should be noted that a financial institution may include a bank, a company, an enterprise, a private equity company, and the like.

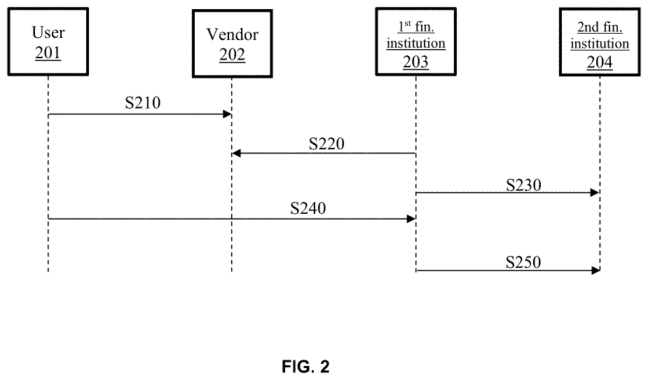

FIG. 2 is an example flow diagram illustrating the monetary transactions among various entities according to the disclosed embodiments. The monetary transactions are controlled by the payment system 110.

At S210, a user 201 makes a payment using the payment app (e.g., app 165, FIG. 1) to a vendor 202 through a PoS (e.g., PoS 120, FIG. 1). The payment is a credit transaction, i.e., the payment app serves as a credit card. Such payment is first approved by the payment system.

At S220, a first financial institution 203 reimburses the vendor 202 for the credit transaction. It should be noted that in a typical implementation, a number of credit transactions will be paid to the vendor 202.

At S230, the first financial institution 203 sells a credit tranche representing a group of credit transactions to at least one second financial institution 204 under negotiated payment terms.

At S240, the first financial institution 203 collects debit payments from users (e.g., user 201).

At S250, a payment is made through the tranche to the second financial institution 204 from the first financial institution 203.

It should be noted that all transactions illustrated in FIG. 2 are electronic transactions that are processed by the systems, servers, software, and the like as discussed in FIG. 1. As such, no transaction shown in FIG. 2, can be performed, controlled, or supervised by a human. In fact, in a typical operational environment, there are thousands of transactions to be processed every second, thus it is impractical and impossible to be performed by humans.

It should be further noted that the steps shown in FIG. 2, are performed under the control of the payment system 110. In some configurations, the system 110 may interact with third party systems. For example, the payment system 110 may transact with a security system that can detect fraudulent transactions. The payment system 110 may further transact with third-party systems that may facilitate the collection of payments from end-users.

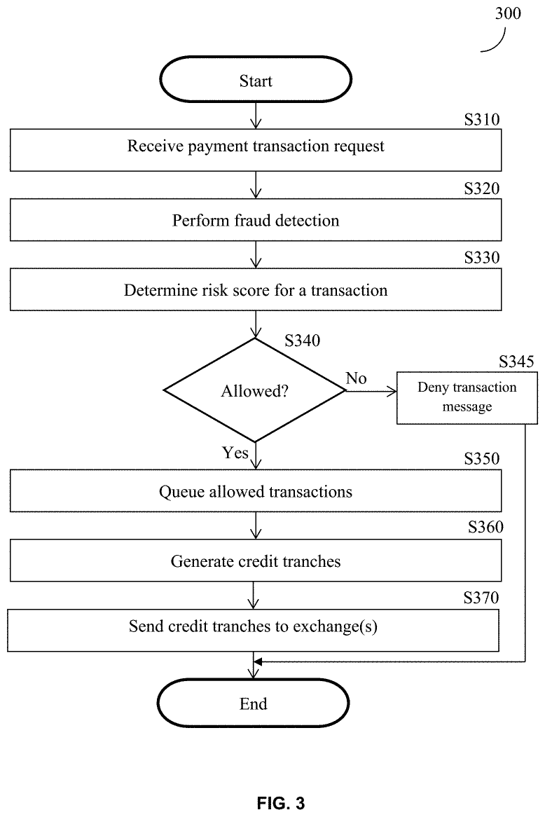

FIG. 3 is an example flowchart 300 illustrating the operation of the payment system 110 according to an embodiment.

At S310, a credit transaction approval request is received. The request may include the user information, vendor information, and requested amount and terms (e.g., installments), and other metadata. The request is initiated by a user device and may occur when a user (payer) and vendor (payee) are in the same location, at the point of sale. Alternatively, the request may occur when user and vendor are in separate locations performing an e-commerce activity.

The metadata may include a transaction time, a geolocation of user and vendor, type of the purchase, and so on. The user information includes at least a unique identifier (ID) identifying the user. The vendor information may include an identifier of the vendor, its type, and the like. The credit transaction approval request may be encrypted.

At S320, a fraud detection process is performed on the received transaction to determine if the transaction is fraudulent or not. A number of techniques are disclosed in the related art to identify such transactions and be utilized by the disclosed system. For example, a fraudulent transaction can be detected based on locations of the vendors with respect to the location of the user device. As another example, the fraudulent transactions can be detected based on history of transactions of the same user. In addition, fraudulent activity can also be detected using machine learning models configured to classify transactions based on patterns. The patterns include, for example, transaction frequency, transaction's amounts, type of purchased products/services, internal user networks activity, and the like. In an embodiment, a fraud detection is provided by a third-party application or system. To this end, at S320, a third-party system is queried with the received transaction to determine if the transaction is fraudulent.

At S330, a risk score is determined for the received credit transaction approval request. In an embodiment, the determination is based on the current risk profile of the user. Such a profile is continually learned and updated, therefore providing an accurate indication as to the likelihood that the user pays back. In some example embodiments, the current risk profile is generated by using a know your intentions (KYI) process. An initial profile is generated for the user when subscribing to the payment system. The initial profile may be based on data provided by the user (e.g., income, expenses) and credit score.

The KYI process is configured to correlate multi-dimensional data sources that utilize machine learning to predict customer intentions and optimize customer experience accurately. The method optimizes the amount and data required and prioritize resource allocation on data elements that are most relevant for improving prediction confidence levels.

The data sources being correlated include a mobile device micro-movement, social media platforms, web intelligence services, biometrics, financial transaction details, credit bureau reports, and the likes, or any combination thereof. Micro-movements includes any activity monitor on the user device (such as, web site visited, applications installed, motion information, typing speed, and so on), and information shared between applications (apps) in the user device. Social media platforms any information posted by the users on social media. Web intelligence services provide analysis of social circles. The services can covertly uncover and analyze the data flows from open source web and social networks, augmented with deep web and darknets sources. Biometrics include any biometric identifiers are the distinctive, measurable characteristics used to label and describe individuals. An additional data source is financial information on the user, such as available credit, a number of missed payments, and the like.

The various streams received from data sources are processed by a machine learning model trained to compute a risk score for the received transaction request. The machine learning model may be any of a supervision model, an unsupervised model, or a semi-supervised model.

It should be noted that fraud detection and risk score can be computed on transactions that are being processed as debit transactions.

At S340, it is checked based on the risk score and a fraud indication whether to allow the transaction. In some configurations, the fraud indication computed at FIG. 3 is factored in the risk score. The check may be based on a predefined threshold. If S330 results with a ‘yes’ answer, execution continues with S350. Otherwise, a denied message is sent to the vendor at S345. The risk score and the respective user identifier is saved in the database, such as database 150, FIG. 1 above.

In an embodiment, S310, S320, S330, and S340 are performed by the decision engine 111 discussed above. It should be noted that the decision engine 111 can be separated into different logical entities that communicate through an API.

At S350, several approved credit transactions are collected. This may include collecting several transactions collected during a predefined time interval (e.g., 24 hours) or until a number of transactions are received. The approved credit transactions may be the same vendors or different vendors.

At S360, credit tranches are generated based on the collected transactions. The credit tranches create fungibility, transparency, and thus engender liquidity. A credit tranche is a collection of credit transactions with different attributes, each tranche is associated with a tranche and the value of the tranche. The value is an accumulated amount of the debt of all transactions in a tranche. The value is updated in real time as transactions are paid. In an embodiment, paid transactions are replaced with new credit transactions with the same risk.

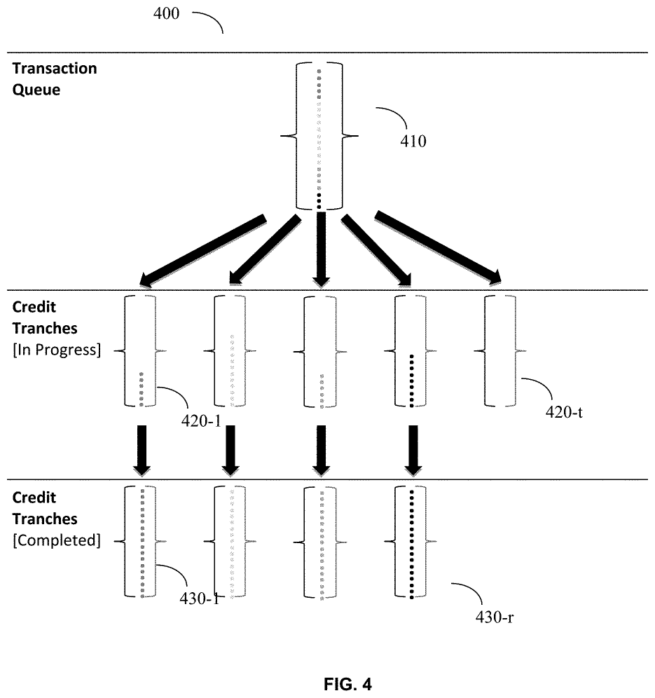

An example diagram 400 illustrating the generation of credit tranches is shown in FIG. 4. First, a transaction queue 410 is filled with approved transactions. Each transaction that is in the queue 410 includes transaction metadata listing the risk score of the transaction, user and vendor information, time, price, quantity, items, channels, and the like.

Then, the queued credit transactions are distributed into credit tranches 420-1 through 420-t (where ‘t’ is an integer greater than 1). A credit tranche can be viewed as a unified set of “portfolio of loans” sharing the same quality of loan. In an embodiment, credit transactions having the same risk score (exact number or a range) are associated with the same credit tranche. For example, transactions with a risk score ‘1’ would be associated with tranche 420-1 and transactions with a risk score ‘10’ would be associated with tranche 420-2. Considering the transaction risker with a higher score, then the transactions in the tranche 420-1 represent a less risky loan than those in tranche 420-2. A score can be associated with the entire tranche 420-1 and be based on external factors, such as a current employment rate, a current market, natural disasters, current political events, and the like. The tranche score is not determined solely based on users submitting the transactions.

The placement of transactions in validated tranches 430-1 through 430-r after processing each transaction is based in part on its risk score. In an embodiment, a validated tranche 430-1, 430-r further includes the value of each tranche, i.e., the loan (debt) value represented by the transactions in the tranche.

In an embodiment, for each validated tranche 430-1, 430-r is a unique value representing a traded financial instrument that can be traded. Such value is generated in real time and fed to the servers 140 in real time to financial institutions to bid or trade the validated tranches. For example, values can be changed if transactions are removed from the tranche (for example, when paid) or when new transactions are added. In some embodiment, transactions can be moved from tranche to tranche.

In a further embodiment, a validated tranche can be split into two or more tranches with fewer transactions. This allows to provide tranches with a smaller debt amount, that might appeal to different categories of investors.

It should be noted that the credit tranches provide standardized financial instruments that can be managed, monitored, and traded in real-time. Further, it ensures that credit transactions (loans) of each tranche are unique and cannot be reused in other tranches.

In an embodiment, the generation of credit tranches is performed by the engine 112, FIG. 1.

Returning to FIG. 3, at S370, the credit tranches are sent to an exchange to solicit bids on the credit tranches. A credit tranche can be sent with metadata including, for example, a credit tranche category (defining percentile of the loans falls into this risk level), a historical performance (loans/customers in this risk level (e.g., the average payout period, default %, etc.), credit tranches of this category (the interest rate auctioned over time), historical demand for credit tranche of this performance, notional value tranches (for an auction, work in progress (WIP), and a secondary market.

In an embodiment, the highest bid on a credit tranche is accepted. The highest may be determined based on a set of predefined parameters, and such parameters may be dynamically updated based on current market conditions. For example, the parameter may include an interest paid on the loan and payment term, the highest bid would be the lowest interest and the longer term. In an example configuration, when no bid is placed or accepted, a designated financial institution is required to bid and thus be the buyer of last resort for the credit tranche. In an embodiment, credit tranches can be traded among institutions. Credit tranches can be traded in the secondary market as well.

In one embodiment, credit tranches can be managed over a Blockchain (decentralized) network, such as Ethereum, and realized as stablecoin, a smart contract, or any other type of cryptocurrency. Here, a form or cryptocurrency is generated or otherwise computed for each credit tranche.

In an example embodiment, the credit tranche engine may assemble the tranche and verify that the loans exist and verify the ownership. The exchange may create cryptocurrency that would be exchangeable in some integer multiple of tranches.

In a blockchain embodiment, the proof of asset function is performed by the tranche system (or any other function in the payment system 110, FIG. 1). This includes verifying payment from the borrower and making payments to the lenders. The Blockchain would contain the registration of the tranche, the chain of digital signatures, and the verification of ownership of the loans.

It should be noted that utilizing blockchain to manage the tranche provides a number of advantages, such as credit market democratization, improved security and verification of ownership, and compliance with financial regulations.

FIG. 5 is an example block diagram of the payment system 110 according to an embodiment. The payment system 110 includes a processing circuitry 510 coupled to a memory 520, a storage 530, and a network interface 540. In an embodiment, the components of the payment system 110 may be communicatively connected via a bus 550.

The processing circuitry 510 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), general-purpose microprocessors, microcontrollers, digital signal processors (DSPs), and the like, or any other hardware logic components that can perform calculations or other manipulations of information.

The memory 520 may be volatile (e.g., RAM, etc.), non-volatile (e.g., ROM, flash memory, etc.), or a combination thereof. In one configuration, computer readable instructions to implement one or more embodiments disclosed herein may be stored in the storage 530.

In another embodiment, the memory 520 is configured to store software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 510, cause the processing circuitry 510 to perform the various processes described herein.

The storage 530 may be magnetic storage, optical storage, and the like, and may be realized, for example, as flash memory or other memory technology, CD-ROM, Digital Versatile Disks (DVDs), or any other medium which can be used to store the desired information.

The network interface 540 allows the payment system 110 to communicate with the exchange servers 140 and the like. Further, the network interface 540 allows the system 110 to communicate with the database 150 for the purpose of collecting information regarding the product.

It should be understood that the embodiments described herein are not limited to the specific architecture illustrated in FIG. 5, and other architectures may be equally used without departing from the scope of the disclosed embodiments.

The embodiments disclosed herein can be implemented as hardware, firmware, software, or any combination thereof. The application program may be uploaded to, and executed by, a machine comprising any suitable architecture. Preferably, the machine is implemented on a computer platform having hardware such as one or more central processing units (“CPUs”), a memory, and input/output interfaces.

The computer platform may also include an operating system and microinstruction code. The various processes and functions described herein may be either part of the microinstruction code or part of the application program, or any combination thereof, which may be executed by a CPU, whether or not such computer or processor is explicitly shown.

In addition, various other peripheral units may be connected to the computer platform, such as an additional network fabric, storage unit, and a printing unit. Furthermore, a non-transitory computer readable medium is any computer readable medium except for a transitory propagating signal.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; A and B in combination; B and C in combination; A and C in combination; or A, B, and C in combination.

All examples and conditional language recited herein are intended for pedagogical purposes to aid the reader in understanding the principles of the disclosure and the concepts contributed by the inventor to furthering the art and are to be construed as being without limitation to such specifically recited examples and conditions.

What is claimed is:

1. A method for facilitating direct trading of electronic transactions, comprising:
receiving a request to approve an electronic transaction;
determining if the received electronic transaction is approved based in part on a risk score set for the received electronic transactions;
tranching the received electronic transaction in a transferable tranche, wherein the transferable tranche includes a plurality of plurality of approved electronic transactions issued by at least two different users; and
providing the transferable tranche to a trading platform to perform at least one action on each of the approved electronic transactions.

2. The method of claim 1, further comprising:
analyzing the received electronic transaction to determine if the electronic transaction is a fraudulent transaction.

3. The method of claim 2, further comprising:
determining a risk score for the received electronic transaction based on a risk profile of a user issued the received electronic transaction, wherein the risk profile is dynamically updated.

4. The method of claim 3, further comprising:
generating a risk profile risk by correlating multi-dimensional data from a plurality of sources; and
utilizing machine learning to predict a user intention based on the correlated multi-dimensional data.

5. The method of claim 3, wherein the received electronic transaction is a credit request transaction and wherein the transferable tranche is a credit tranche.

6. The method of claim 5, wherein the credit request transaction includes at least user information, vendor information, requested credit amount, and requested terms, and metadata.

7. The method of claim 5, wherein each credit tranche is a collection of credit request transactions with different attributes, each tranche is associated with a tranche and the value of the tranche.

8. The method of claim 1, wherein tranching the received electronic transactions further comprises:
forming a transaction queue including approved credit request transactions, wherein each request credit transaction in the queue includes transaction metadata;
distributing queued credit request transactions in the transaction queue into at least one credit tranche; and
placing credit request transactions in a validated credit tranche based on their respective risk score, wherein a validated credit tranche is a portfolio of loans sharing the same quality of loan and a risk score.

9. The method of claim 1, wherein providing the transferable tranche to a trading platform further comprises:
soliciting bids on each validated credit tranche;
accepting a highest bid determined based on at least monetary parameter; and
transferring the validated credit tranche to allow processing of credit request transactions stored therein, wherein the to the validated credit tranche is transferred to an institution providing the highest bid.

10. The method of claim 9, further comprising:
updating, in real-time, a value of transferable tranche as transactions in the respective transferable tranche; and
replacing paid transactions with new credit transactions having a same risk score of the paid transactions.

11. The method of claim 6, wherein the trading platform is any one of: at least one exchange system and a blockchain network.

12. The method of claim 6, wherein the financial institution bidding on a credit tranche is different from an institution paying vendors and approving the credit request transactions.

13. The method of claim 12, further comprising:
optimizing the risk score based on at least history payment of transactions in at least one credit tranche.

14. A non-transitory computer readable medium having stored thereon instructions for causing a processing circuitry to execute a process for facilitating direct trading of electronic transactions, the process comprising:
receiving a request to approve an electronic transaction;
determining if the received electronic transaction is approved based in part on a risk score set for the received electronic transactions;
tranching the received electronic transaction in a transferable tranche, wherein the transferable tranche includes a plurality of plurality of approved electronic transactions issued by at least two different users; and
providing the transferable tranche to a trading platform to perform at least one action on each of the approved electronic transactions.

15. A system for facilitating direct trading of electronic transactions, comprising:
a processing circuitry; and
a memory, the memory containing instructions that, when executed by the processing circuitry, configure the system to:
receive a request to approve an electronic transaction;
determine if the received electronic transaction is approved based in part on a risk score set for the received electronic transactions;
tranche the received electronic transaction in a transferable tranche, wherein the transferable tranche includes a plurality of plurality of approved electronic transactions issued by at least two different users; and
provide the transferable tranche to a trading platform to perform at least one action on each of the approved electronic transactions.

16. The system of claim 15, wherein the system is further configured to:
analyze the received electronic transaction to determine if the electronic transaction is a fraudulent transaction.

17. The system of claim 16, wherein the system is further configured to:
determine a risk score for the received electronic transaction based on a risk profile of a user issued the received electronic transaction, wherein the risk profile is dynamically updated.

18. The system of claim 17, wherein the system is further configured to:
generate a risk profile risk by correlating multi-dimensional data from a plurality of sources; and
utilize machine learning to predict a user intention based on the correlated multi-dimensional data.

19. The system of claim 17, wherein the received electronic transaction is a credit request transaction, and wherein the transferable tranche is a credit tranche.

20. The system of claim 19, wherein the credit request transaction includes at least user information, vendor information, requested credit amount, and requested terms, and metadata.

21. The system of claim 19, wherein each credit tranche is a collection of credit request transactions with different attributes, each tranche is associated with a tranche and the value of the tranche.

22. The system of claim 15, wherein the system is further configured to:
form a transaction queue including approved credit request transactions, wherein each request credit transaction in the queue includes transaction metadata;
distribute queued credit request transactions in the transaction queue into at least one credit tranche; and
place credit request transactions in a validated credit tranche based on their respective risk score, wherein a validated credit tranche is a portfolio of loans sharing the same quality of loan and a risk score.

23. The system of claim 15, wherein the system is further configured to:
solicit bids on each validated credit tranche;
accept a highest bid determined based on at least monetary parameter; and
transfer the validated credit tranche to allow processing of credit request transactions stored therein, wherein the to the validated credit tranche is transferred to an institution providing the highest bid.

24. The system of claim 15, wherein the system is further configured to:
update, in real-time, a value of transferable tranche as transactions in the respective transferable tranche; and
replace paid transactions with new credit transactions having a same risk score of the paid transactions.

25. The system of claim 19, wherein the trading platform is any one of: at least one exchange system and a blockchain network.

26. The system of claim 19, wherein the financial institution bidding on a credit tranche is different from an institution paying vendors and approving the credit request transactions.

27. The system of claim 15, wherein the system is further configured to:
optimize the risk score based on at least history payment of transactions in a at least one credit tranche.
